(19) United States
(12) Patent Application Publication
(10) Pub. No.: US 2024/0273438 A1
(43) Pub. Date: Aug. 15, 2024

(54) SYSTEMS AND METHODS FOR DISPLAYING, ANALYZING, AND ACTIONING AGGREGATED DATA FROM HETEROGENOUS COMMUNICATIONS PLATFORMS

(71) Applicant: Theta Lake, Inc., Santa Barbara, CA (US)

(72) Inventors: Derek Gordon Brenner, Lompoc, CA (US); Gary Philip Pinkham, Reading, MA (US); Beatriz Gomes, Santa Barbara, CA (US); Daniel Oshiro Nadir, Carlsbad, CA (US); Richard B. Sutton, San Mateo, CA (US); Devin H. Redmond, Encinitas, CA (US); Marc Gilman, Santa Barbara, CA (US)

(21) Appl. No.: 18/438,115

(22) Filed: Feb. 9, 2024

Related U.S. Application Data
(60) Provisional application No. 63/484,085, filed on Feb. 9, 2023.

(51) Int. Cl. G06Q 10/0635; G06F 3/04817

(52) U.S. Cl. CPC G06Q 10/0635; G06F 3/04817

(57) ABSTRACT

Systems and methods facilitate aggregating, visualizing, analyzing, and actioning communication data from multiple communications systems. Searches can be executed using, among other items, one or more individual attributes like email address, name, phone number, etc. even when items don't contain the searched attribute. The systems and methods may provide analysis of conversations and display relationships between conversations and participants, risks or themes within or across conversations, as well as ascertaining trends and anomalous behavior among conversations and participants. In some embodiments, these functions are completed within a unified visual interface, and without requiring users to define user identities, execute searches, or analyze relationships across multiple conversations and communication platforms.

### CROSS-REFERENCE TO RELATED APPLICATION(S)

This application claims a benefit of priority under 35 U.S.C. § 119(e) from U.S. Provisional Application No. 63/484,085, filed Feb. 9, 2023, entitled “SYSTEMS AND METHODS FOR DISPLAYING, ANALYZING, AND ACTIONING AGGREGATED DATA FROM HETEROGENEOUS COMMUNICATIONS PLATFORMS,” which is fully incorporated by reference herein for all purposes.

### TECHNICAL FIELD

This disclosure relates to the field of electronic communications supervision and analysis. More particularly embodiments relate to aggregating, visualizing, analyzing, and actioning data from multiple communications systems.

### BACKGROUND

In a typical enterprise or organization, users may communicate with one another over multiple communications platforms, for example via email, chat, SMS, collaboration applications, voice, video, etc. In order to search, supervise, and gather insights from communications within or across multiple communications platforms, IT administrators, compliance, risk, cybersecurity, human resources, or other control functions may have to search and retrieve multiple individual messages from relevant electronic archives and manually stitch together conversations in an attempt to analyze them. These types of labor-intensive manual searches would be performed by searching on a single or multiple user identifier such as a name, email address, or telephone number, which must be input to execute the search. Attempts to relate or analyze retrieved conversations in an aggregate manner-to identify patterns of the participants, or to examine interesting or risky portions of the conversations-would require extended application of the same manual efforts with inferior results to solutions described below. This poses the technical problem of providing systems that could display, analyze, and take action on data from a plurality of communications platforms, which would be desirable. Given the manual efforts involved in analyzing the data, such analysis, without a system in place to solve the technical problems, such a manual effort would be relatively rudimentary. While some existing oversight, surveillance and supervision applications can display connections between one or two communications platforms, like email and voice recording platforms, and incorporate data from financial trading systems, the ability to comprehensively visualize, search, and analyze interactions across multiple, disparate, communications platforms does not exist. In addition, if a conventional system were configured to allow users to manually search numerous heterogeneous communications platforms, such a system would be inefficient and complicated. A system that enabled the displaying, analyzing, and actioning of data aggregated from heterogeneous communications platforms would result in a system that would be more efficient, use less resources, and be more usable, versus using conventional systems to attempt to duplicate such actions.

As discussed above, existing oversight platforms may provide the ability to search a limited set of communication channels, such as a single voice recording or email platform and associate a set of data with a financial transaction platform. However, the results of this type of analysis are limited and do not incorporate conversation data from multiple communications platforms, nor do they facilitate the breadth of analysis of the conversation data or the ability to take subsequent actions like create or refine workflows, take e-discovery actions, or create archiving or routing rules.

One problem solved by the disclosure below is the ability to centrally display and analyze complex communications data from multiple electronic communications platforms. Specifically, in some embodiments, the disclosed invention facilitates the ability to view relationships between users across multiple communications platforms in a single view, analyze the details, patterns, and risks of those cross-platform conversations, and take subsequent actions such as creating workflows, archiving, or classifying data.

### SUMMARY

A system includes a memory, a processor, and a non-transitory, computer-readable storage medium storing a set of instructions executable by the processor, the set of instructions comprising instructions for ingesting communication data from a plurality of heterogeneous communication platforms, the communication data relating to communications between two or more participants in an enterprise and including different types of media, normalizing the communication data ingested from the plurality of heterogeneous communication platforms, aggregating and analyzing the normalized communication data, providing a user interface enabling a user to submit a search query relating to participants or subject matters, and presenting, over the user interface, search results, including visual representations of communications between two or more participants relating to the search query.

Another embodiment provides a method including ingesting communication data from a plurality of heterogeneous communication platforms, the communication data relating to communications between two or more participants in an enterprise and including different types of media, normalizing the communication data ingested from the plurality of heterogeneous communication platforms, aggregating and analyzing the normalized communication data, providing a user interface enabling a user to submit a search query relating to participants or subject matters, and presenting, over the user interface, search results, including visual representations of communications between two or more participants relating to the search query.

Another embodiment provides a computer programming product comprising a non-transitory computer-readable medium storing instructions translatable by a processor for ingesting communication data from a plurality of heterogeneous communication platforms, the communication data relating to communications between two or more participants in an enterprise and including different types of media, normalizing the communication data ingested from the plurality of heterogeneous communication platforms, aggregating and analyzing the normalized communication data, providing a user interface enabling a user to submit a search query relating to participants or subject matters, and presenting, over the user interface, search results, including visual representations of communications between two or more participants relating to the search query.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a diagram illustrating one example of a screenshot showing participants and participant interactions in a graph across various communications platforms.

FIG. 2 is a diagram illustrating one example of a screenshot showing a communication relationship between a primary participant and a connected participant.

FIG. 3 is a diagram illustrating one example of a screenshot showing participants and participant interactions in a graph across various communications platforms where a user has focused on a new primary participant.

FIG. 4 is a diagram illustrating one example of the interactions between two users with records as aggregated media types.

FIG. 5 is a diagram illustrating one example of the interactions between two users, including ancillary participants.

FIGS. 6-7 are diagrams illustrating examples of screenshots showing streams of communications between participants.

FIG. 8 is a block diagram of one embodiment of a process for aggregating, visualizing, analyzing, and actioning communication data from multiple communications systems.

FIG. 9 is a diagram illustrating a screenshot showing an example of an AI generated conversation summary.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Before discussing embodiments of systems and methods for displaying, analyzing, and actioning aggregated data from heterogeneous communications platforms in more detail, a brief description of the context in which embodiments can be utilized may be helpful. Applications such as human resource (HR) applications, customer relationship management (CRM) applications, email applications, office applications (word processors/spreadsheets), communications applications (e.g., collaboration, chat, and video), and other applications, may pose risks to an organization, for example, if users share or disclose certain types of information over one of the communications platforms. It is sometimes desirable to monitor communications in order to adhere to an enterprise's compliance, privacy, cybersecurity, HR, and conduct policies. Embodiments relating to the enforcement of security and compliance controls for electronic data and communications may be better understood with reference to the following commonly-owned U.S. Patent Applications: U.S. patent application Ser. No. 17/378,481, entitled “SYSTEMS AND METHODS FOR MONITORING AND ENFORCING COLLABORATION CONTROLS ACROSS HETEROGENEOUS COLLABORATION PLATFORMS” by Nadir et al., filed on Jul. 16, 2021; U.S. patent application Ser. No. 17/883,221, entitled “SYSTEM AND METHOD FOR VISUAL IDENTIFICATION OF DISPLAYED APPLICATIONS IN ELECTRONIC COMMUNICATIONS” by Hüffner et al., filed on Aug. 8, 2022; U.S. patent application Ser. No. 17/741,528, entitled “SYSTEM AND METHOD FOR ANALYZING REALTIME DATA FROM HETEROGENEOUS COLLABORATION PLATFORMS TO IDENTIFY RISK” by Nadir et al., filed on May 11, 2022, each of which are incorporated herein by reference in their entireties for all purposes. Embodiments described herein provide computer-based technologies to aggregating, visualizing, analyzing, and actioning data from multiple communications systems. Besides identifying potential risks to an enterprise, the disclosed systems and methods can be used for any other desired purpose. For example, an organization can use the system for HR purposes (e.g., investigating employee issues), financial services risks (complaints, collusion, sharing of material non-public information, and other non-compliance with relevant SEC, FINRA, FCA, or other regulations) marketing purposes (e.g., determining potential clients/customers based on employee communications), etc.

In some embodiments, the disclosed systems and methods can be delivered as a component of systems such as Theta Lake's cloud-based software, which ingests content from over 50+ communications platforms. The disclosed systems and methods can also be used in other contexts, as one skilled in the art would understand. In some embodiments, the ingested data is normalized, so that the data from different communications platforms can be used together, as described below. The disclosed systems and methods facilitate simplified, easy searching of one or more individuals, topics, or risks within or across multiple electronic communications platforms. Searches can be executed using, among other items, one or more individual attributes like email address, name, phone number, etc. even when items don't contain the searched attribute. For example, a user could search for “department 15,” which would return records where “department 15” was mentioned in the conversation as well as where “department 15” was part of the metadata for a user. The system maintains an identity mapping that links “department 15” to many different IDs, including a communication platform ID, an email address, phone numbers, or other identifiers. Therefore, a search for “department 15” would return any users who are part of the organizational unit “department 15” and any conversations including that term. In addition, the disclosed systems and methods may provide analysis of conversations to display relationships between conversations and participants, risks or themes within or across conversations, as well as ascertaining trends and anomalous behavior among conversations and participants. In some embodiments, all of these functions are completed within a unified visual interface (described in detail below), and without requiring users to define user identities, execute searches, or analyze relationships across multiple conversations and communication platforms.

In some embodiments, based on the results of a search, additional searches or exploration of conversations for specific machine learning-based risk detections, timespans, additional conversation participants, or files attached in conversations can be automatically conducted.

Ultimately, information from searches can be used to create new rules for the automated routing of conversations for review, e-discovery preservation actions, archiving/retention rules, workflows, freedom of information request compliance, and more.

For example, an administrator of an enterprise or organization could search all conversations between user1 and user2 based on their email addresses and phone numbers about ACME stock. Based on these search parameters, the system would automatically display a historical view of conversations on multiple platforms as they discuss ACME over email, Slack, Zoom, on a recorded telephone line, etc. In addition, the administrator could create a new workflow rule to, for example, route any Slack conversation about ACME between user1 and user2 that appeared to be collusion to a specific supervisory team for review. Moreover, the system would automatically display a historical view of conversations on multiple platforms providing important context and the full conversation over (all these platforms) even if ACME isn't explicitly mentioned. For example, one text message might say “Yes, I'm not uncertain.” which out of context is meaningless, but when paired with “Are you sure that this merger is going through” and followed by “Cool!” fills in the blanks when this single text message might never be discovered because ACME isn't mentioned and it isn't part of the email thread. Numerous other examples are also possible, as one skilled in the art would understand.

There are multiple practical and technical advantages that the disclosed systems and methods provide over existing manual mechanisms for searching and analyzing communications data. The invention provides a unified mechanism for searching within and across communications platforms for specific risks, participants, themes, or issues. Visually, results and insights of relationships may be presented in a single location for ease of navigation (discussed below). Search results may be presented in a way that facilitates easy ways to drill down on details about a specific risk, user, communication platform, or other parameter. Based on the results, additional risk analysis, workflows, and data management techniques can be applied to existing and new data. Overall, the disclosed systems and methods (besides enabling new features and abilities) can eliminate the highly manual processes associated with searching communications data, allowing for more powerful and efficient analysis. The disclosed systems and methods also extend the number of searchable platforms.

As mentioned above, the disclosed systems and methods may be delivered as a component of systems such as Theta Lake's cloud-based software, which ingests content from over 50+ communications platforms using application programming interfaces (APIs), REST-ful HTTP/S APIs, data exports downloaded via SFTP or other file serving technology, SMTP journal email flows, or other mechanisms. The disclosed systems and methods facilitate simplified, easy searching of one or more individuals within a particular communication and across multiple conversation platforms. Searches can be executed using one or more individual attributes like email address, name, phone number, etc. In addition, the invention provides analysis of conversations to display relationships between conversations and participants, risk or themes within or across conversations as well as ascertaining trends among conversations and participants. All of these functions can be completed within a unified visual interface and without manual efforts to define user identities, execute searches or analyze relationships across multiple conversations and communication platforms.

From a technical perspective, the disclosed systems and methods can be implemented using graph databases, relational databases, no-SQL databases (e.g., Cassandra), document databases (e.g., MongoDB), file stores (e.g., S3), and any storage engine that implements search (e.g., Elasticsearch, AWS Athena). There are multiple technical mechanisms that can be used to deploy the disclosed systems and methods, as one skilled in the art would understand.

So, for example, as discussed above, an administrator could use the disclosed systems and methods to search all conversations between user1 and user2, based on their respective email addresses and phone numbers, about ACME stock. Based on these search parameters, the system can display a historical view of conversations on multiple platforms, as the participants discuss ACME over email, Slack, Zoom, and on a recorded telephone line. The display of conversations provided by the system can be further configured based on messaging platform, participants, risks identified, etc. To facilitate the identification of specific risks, users can deploy one of Theta Lake's 70+ machine learning-based detections for regulatory, security, or privacy risks (discussed above). Based on the results of the search, additional searches or exploration of conversations for specific risk detections, timespans, additional conversation participants, or files attached in conversations can be conducted. Ultimately, information from these searches can be used to create new rules for routing conversations for review, e-discovery preservation actions, archiving/retention rules, workflows, and more, as one skilled in the art would understand.

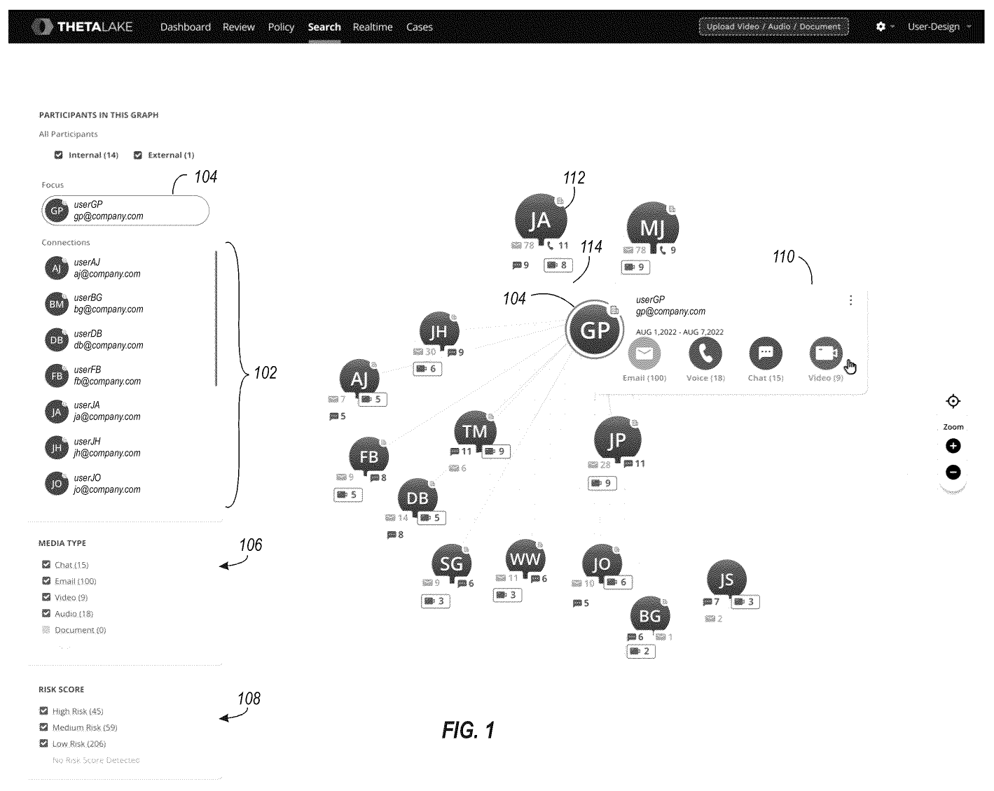

FIGS. 1-7 are screenshots showing examples of unified visual interfaces that illustrate examples of aggregating and visualizing data from multiple communications systems. The examples in FIGS. 1-7 show various hypothetical users and hypothetical dates. FIG. 1 shows an example of a screenshot showing participants and their interactions in a graph across various communications platforms. At the left, a list 102 of participants (users) is shown, including one primary participant (userGP 104) shown as a focal point, and several others (listed below userGP 104) that have some connection to userGP 104. Below the list 102 of participants, FIG. 1 shows menus 106, 108 that enable a user to filter results, for example, by selecting media types 106, risk scores 108, etc. Numerous other menus may be included off-screen or in other views, as one skilled in the art would understand. To the right of the list 102, the primary participant (userGP 104) is shown with communication connections with the other participants, shown be lines connecting the respective participants to the primary participant 104. The graph shows the participant 104 that the graph is focused on (GP) and the amounts and types of communications they have had with the connected participants (via the icons and numbers, as shown near each participant). For the primary participant (GP 104), the dialog box 110 displays a name and email address of the participant 104, as well as the number and type of communications relating to GP 104. In the same dialog box 110, a date range is shown, which may have been specified by the individual conducting the search, to filter the results to a specific date range.

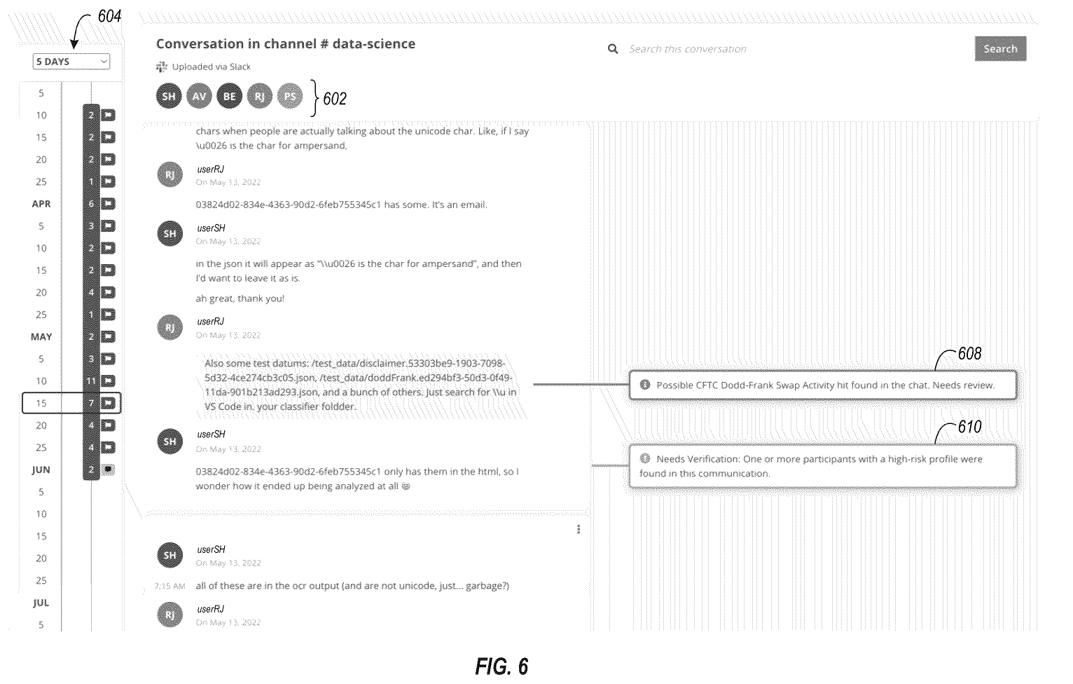

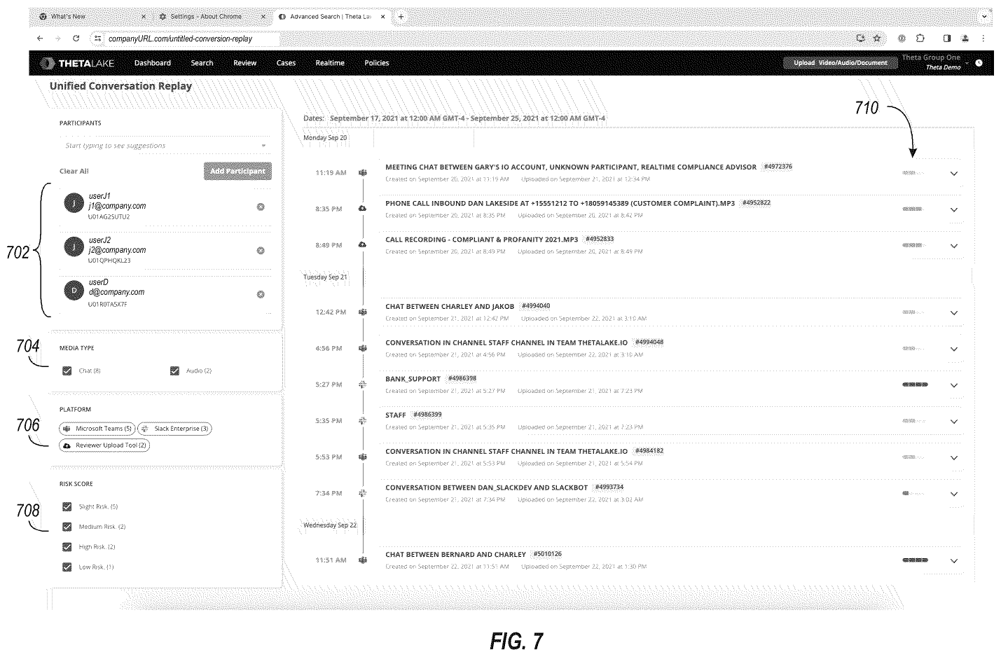

As mentioned above, in the example shown, connections between the primary participant and the others are shown with a line and indicators (icons) as to the types and amount (numbers) of communications are also shown. In other words, the lines in FIG. 1 represent aggregated data of a certain type(s). For example, the communications between userGP 104 and userJA 112 resulting from a search are represented by the line 114, and the communications include 78 emails, 11 phone calls, 9 messages, and 8 video communications, as indicated by the icons and numbers positioned proximate userJA 112. In some embodiments, when a user selects, hovers over, etc., one of the icons, further information for those corresponding communications can be displayed. Similarly, the lines (e.g., line 114, with respect to userGP and userJA) can also be interactive, such that additional information (including the communications themselves) is displayed in response to a user clicking, hovering over, etc., a respective line. FIG. 1 can be thought of as a visual representation of data that enables a user to see patterns in a way that is not obvious from just viewing the data in a table. Also note that the system enables a user to easily navigate to the specific communications represented in the graph of FIG. 1. For example, FIGS. 6 and 7 (discussed below) show examples of displaying specific communications selected by a user of the system. Also note that the various lines in the figures representing the communications can be coded (by color, etc.) to convey additional information, if desired. For example, a communication identified as high risk, could be a certain color (or dashed, for example).

Note that the term “graph” is intended to refer to the concept of an abstract data type meant to implement graph concepts from the field of graph theory within mathematics. A typical graph data structure consists of a set of vertices (also called nodes or points), together with a set of unordered pairs of these vertices for an undirected graph or a set of ordered pairs for a directed graph, as one skilled in the art would understand. These pairs are known as edges (also called links or lines), and for a directed graph are also known as edges, arrows, or arcs. Of course, the data can also be displayed in non-graph representations.

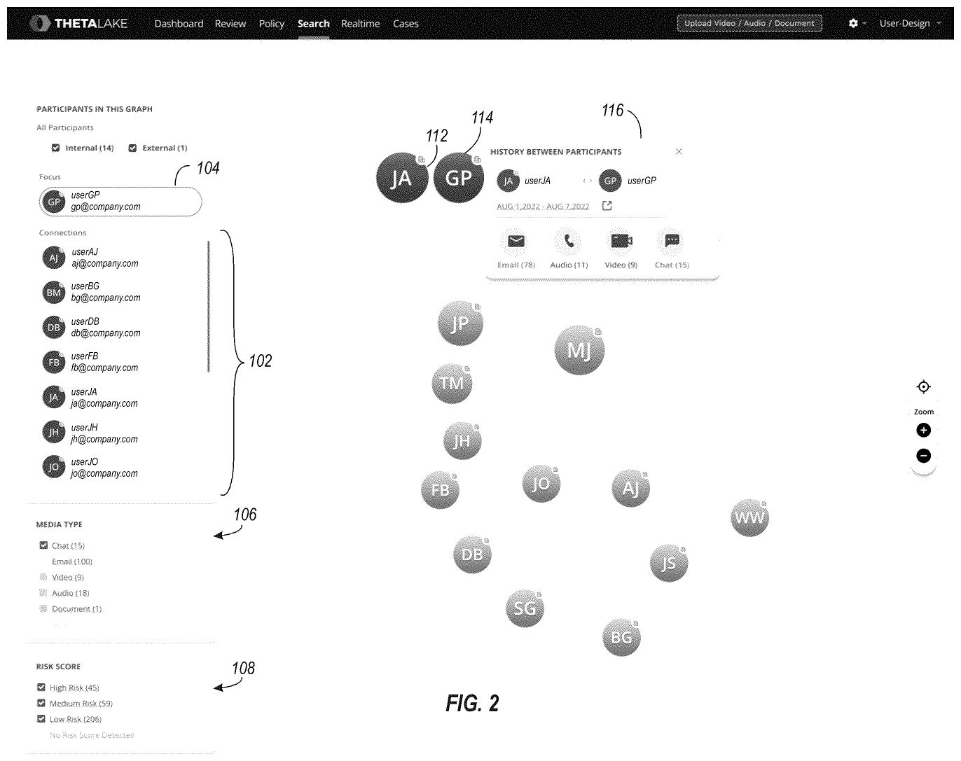

FIG. 2 shows an example similar to FIG. 1, showing a communication relationship between the primary participant 104 (in this example, GP) and a single connected participant 112 (in this example, JA). As shown in the dialog box 116 (labeled “History Between Participants”), the amount and type of communications between the primary participant 104 (GP) and a single other participant (participant 112 (JA), in this example) is displayed. In this example, the display (box 116) shows that there were 78 emails, 11 calls, 9 videos, and 15 chats between the participants 104 and 112 that resulted in a search.

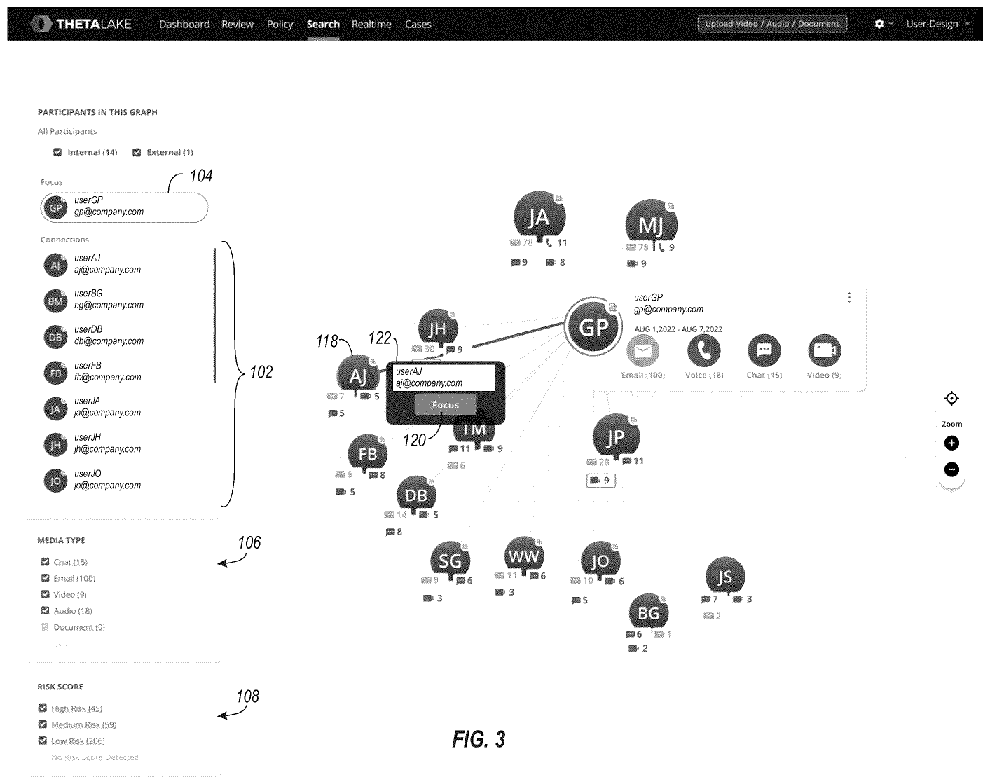

FIG. 3 shows an example similar to FIG. 1, where the user is refocusing on a new primary participant 118 (in this example, userAJ). The system allows the user to refocus the graph on another participant, so that the user can analyze that participant's communication modes and connections. In the example shown, when a user selects participant 118 (userAJ), the user can select the “Focus” button 120 in a dialog box 122 to change the focus. Once the user selects the focus button 120 (corresponding to userAJ), the resulting graph (not shown) would be similar to the examples in FIGS. 1 and 2, but with the focus on userAJ, instead of userGP.

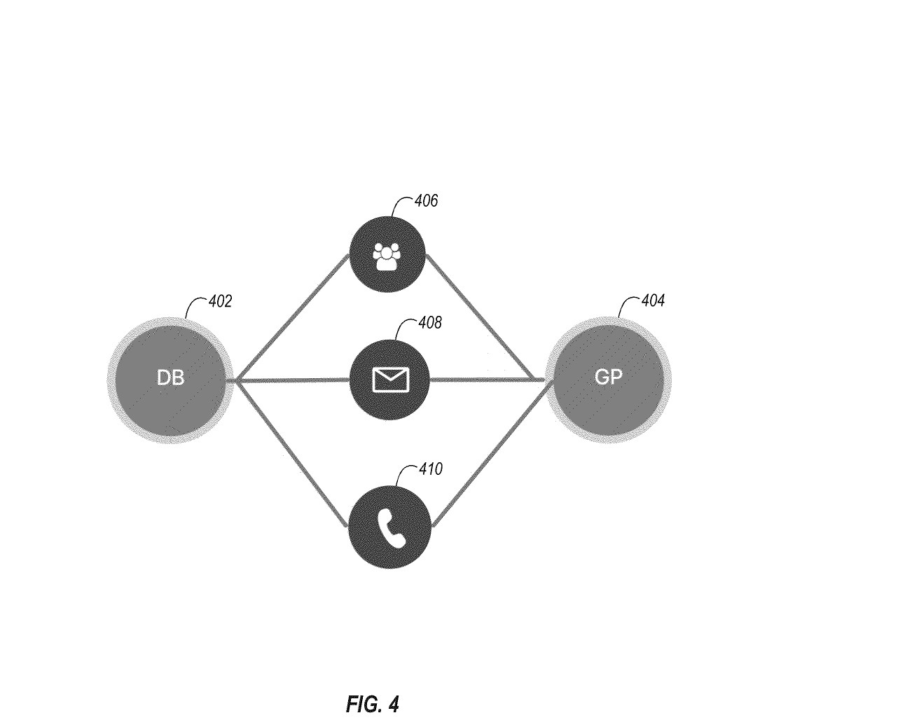

FIG. 4 shows an exemplary diagram illustrating the interactions between two users with records as aggregated media types or other groupings. In this exemplary view, ancillary participants are not shown. In this example, interactions between user 402 (userDB) and user 404 (userGP) are shown. In this example, communications over different media types chat (406), e-mail (408), and voice (410) are grouped together. For example, all emails can be grouped together, all phone calls can be grouped together, all chats can be grouped together, etc., as desired. FIG. 4 is intended to merely show another example of aggregated data between two participants (402 and 404 in the example of FIG. 4), as one skilled in the art would understand. In the example of FIG. 4, grouped phone, email, and chat communications are shown between users DB and GP.

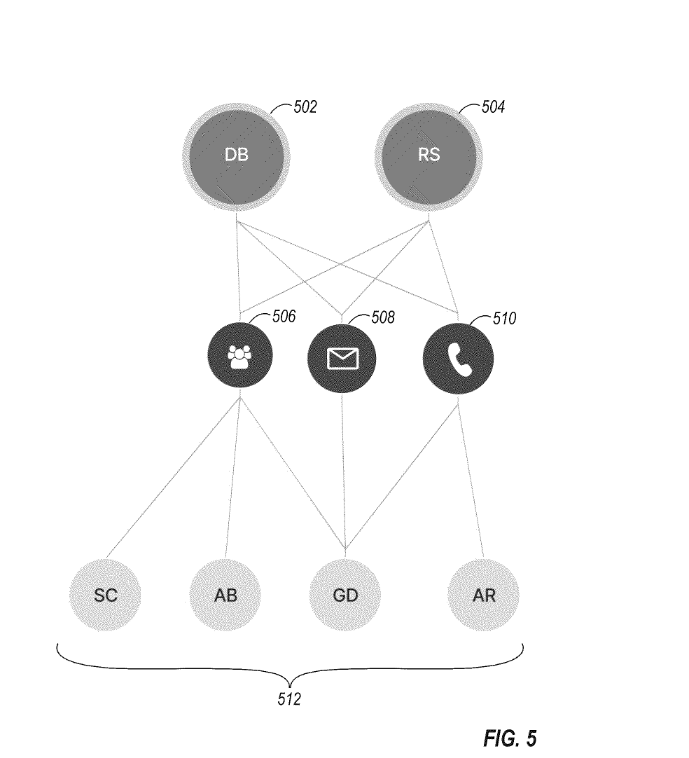

FIG. 5 also shows an exemplary diagram illustrating the interactions between two users with records as aggregated media types or other groupings. FIG. 5 is similar to FIG. 4, but also shows ancillary participants. In this example, communications (chats, emails, calls) are shown between participants 502 (userDB) and 504 (users). As with FIG. 4, in this example, communications over different media types 506, 508, 510 are grouped together. For example, all emails can be grouped together, all phone calls can be grouped together, all chats can be grouped together, etc., as desired. FIG. 5 also shows ancillary participants 512 (userSC, userAB, userGD, and userAR), with indications of their relationship to the communications identified. For example, FIG. 5 indicates that userAR was involved in at least one phone communication (media type 510), but not in email or chat communications. In contrast, userGD was involved in all three media types 506, 508, 510. Note that, while not shown in FIG. 5, the display can include lists of participants, filters, etc., as discussed above and shown in the other figures.

As discussed above, from the various graphs enabled by the disclosed systems and methods, a user can view the specific communications represented in the graphs. FIGS. 6-7 illustrate examples of the ability to view communications (a “stream view”) from graphs, such as those discussed above.

In the example shown in FIG. 6, a chat conversation is shown involving participants 602 (in the example shown, participants SH, AV, BE, RJ, and PS). In this example, a menu 604 enables a user to see the conversation and related risks (indicated by the red flags) across a time span of the user's setting. Chat conversations across days, months, or years can be displayed and seamlessly scrolled through from a single interface. For a selected day (May 15, in this example) a respective conversation 606 is shown, including any desired information, such as content flagged (e.g., flags 608, 610) for review, involvement of high-risk participants, etc., as one skilled in the art would understand. In the example shown in FIG. 6, flag 608 identifies a risk (“possible CFTC Dodd-Frank Swap Activity . . . ”) and suggests a review. Similarly, flag 610 identifies a risk (“. . . One or more participants with a high-risk profile were found in this communication”) and suggests a need for verification. The conversation 606 indicates which communications came from which users, and includes information, such as a date, time (not shown), etc.

The example shown in FIG. 7 (labeled “Unified Conversation Replay”) is similar to the view of FIG. 6, but shows a view of multiple conversations across different platforms between two or more selected participants over a given time period. In the example of FIG. 7, the UI enables a user to select, for a given search, two or more participants (users 702), one or more media types 704 (e.g., chat, audio, video, email, whiteboard, etc.), platforms (e.g., Microsoft Teams, Slack Enterprise, etc.), and risk score 708 (e.g., slight, medium high, low). When a user is viewing search results, these selections enable a user to filter the results by users, media types, platform, risk score, and other desired parameters that the system may have built into the system. The resulting conversation(s) is displayed on the right portion of the screen. In the example of FIG. 7, the display shows three conversations on Monday, September 20, including a Teams meeting, a phone call, and a voicemail. Various details of these items can be displayed on the screen. In addition, the user can view more details, or the media itself by selecting/hovering/etc. on the desired item, or by selecting a pull-down button. In the example of FIG. 7, a risk indicator 710 is provided for each item to indicate a level of risk, as determined by the system. In the example shown the risk indicator shows a bar graph indicating a risk level. In addition, the indicator can use different colors to enable the user to view the risk level easier.

The disclosed systems and methods also have the ability to create a summary of the conversations using artificial Intelligence (AI). For example, the AI can generate a summary of all conversations between two or more participants over a given time period, across multiple platforms. So, in addition to the graphical presentation of data (e.g., FIGS. 1-7), the system can generate summaries of conversations to help users view desired information in a more efficient manner. Such summaries can be configured, as desired, for example, by providing a one sentence/one paragraph/etc. summary of a given conversation between selected participants or relating to a given subject matter. The AI can also be used to make determinations about the conversations. For example, the AI can be used to determine whether or not a new conversation is a continuation of a previous conversation, a new conversation, etc.

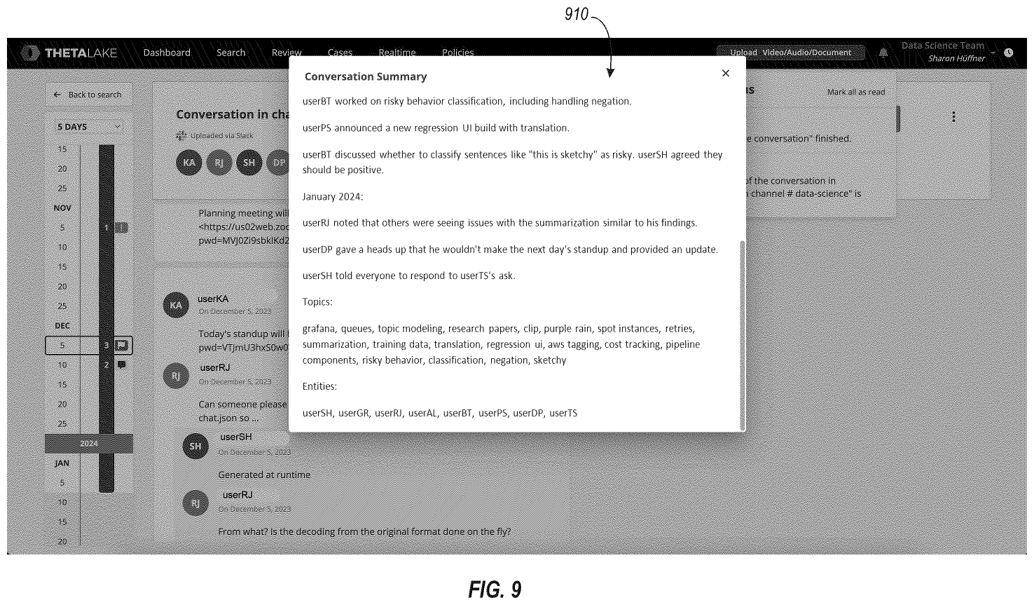

FIG. 9 is a diagram illustrating one example of a screenshot showing an AI generated summary of conversations between various participants. In some embodiments, a button or menu item is available for a user to select to display or publish an AI generated conversation summary. In the example of FIG. 9, a user, while viewing a conversation view, similar to that shown in FIG. 6, selected a button/menu item/etc. to display an AI generated conversation summary. As shown, a dialog box 910 is displayed, which, in this example, has a list of summarized items, such as “userBT worked on risky behavior classification, including handling negation” and “userBT discussed whether to classify sentences like ‘this is sketchy’ as risky. userSH agreed they should be positive.” In addition, the AI summary includes a list of topics and Entities (in this example, users) included in the AI summary. An AI generated summary can include any other desired information, as one skilled in the art would understand.

The disclosed systems and methods can use AI in any desired manner, as one skilled in the art would understand. In some examples, an off-the-self large language model (LLM), or other type of machine learning model, can be trained and configured to generate the desired outputs, as one skilled in the art would understand.

The disclosed systems and methods also have the ability to provide a graphical representation (i.e., a “cluster graph”) of clusters of participants that are communicating often, or are closely related, for example, rather than just select users (e.g., like in FIG. 1). This cluster graph can enable the display which participants are communicating with one another, or which clusters of people are commutating together, for example. In one example, a cluster graph could display all communications between participants about a given topic, event, etc.

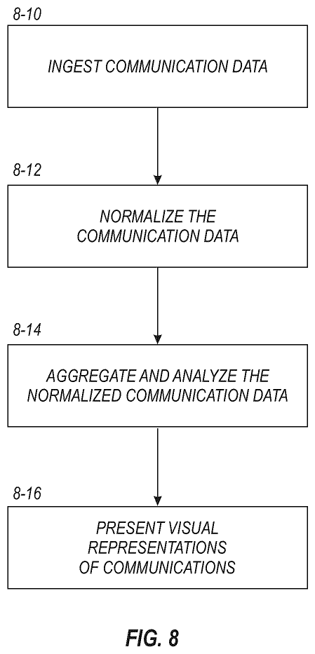

FIG. 8 is a flow chart illustrating an exemplary embodiment of a process for aggregating, visualizing, analyzing, and actioning communication data from multiple communications systems. The disclosed techniques can also be used for other purposes, as one skilled in the art would understand.

At step 8-10 a system ingests communication data from a plurality of heterogeneous communication platforms, as discussed in detail above. The communication data relates to communications between two or more participants in an enterprise and including different types of media (text/email, audio/voice, video, chats, etc.). In some embodiments, the system makes API calls to communication platforms to ingest communication data. In other examples, data is ingested in other ways. Also as discussed above, the ingested data (coming from different communication platforms) is normalized (step 8-12) by the system. At step 8-14, the ingested and normalized communication data is aggregated and analyzed. At step 8-16, the system presents visual representations of communications between two or more participants. As discussed in detail above, the information can be presented in any desire manner. In addition, the system enables a user to perform search queries, and to customize the displayed information (see discussion above with respect to FIGS. 1-7).

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways to implement the invention.

It is also within the spirit and scope of the invention to implement in software programming or code the steps, operations, methods, routines, or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only, but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

What is claimed is:

1. A system comprising:
a memory;
a processor; and
a non-transitory, computer-readable storage medium storing a set of instructions executable by the processor, the set of instructions comprising instructions for:
ingesting communication data from a plurality of heterogeneous communication platforms, the communication data relating to communications between two or more participants in an enterprise and including different types of media;
normalizing the communication data ingested from the plurality of heterogeneous communication platforms;
aggregating and analyzing the normalized communication data;
providing a user interface enabling a user to submit a search query relating to participants or subject matters; and
presenting, over the user interface, search results, including visual representations of communications between two or more participants relating to the search query.

2. The system of claim 1, wherein the different types of media include text and audio.

3. The system of claim 1, wherein the plurality of heterogeneous communication platforms include at least two of: an email platform, a chat platform, a video platform, and a voice platform.

4. The system of claim 1, wherein ingesting communication data includes making application programming interface (API) calls to one or more of the communication platforms.

5. The system of claim 1, wherein the visual representations of communications between two or more participants include an indication of the types of communications between the two or more participants.

6. The system of claim 5, wherein the visual representations of communications between two or more participants include an indication of the number of each of the types of communications between the two or more participants.

7. The system of claim 1, wherein the visual representations of communications between two or more participants include a list of occurrences of communications between first and second participants.

8. The system of claim 7, wherein, one or more of the occurrences of communications between first and second participants include an indication of a risk level relating to the respective communication.

9. A method comprising:
ingesting communication data from a plurality of heterogeneous communication platforms, the communication data relating to communications between two or more participants in an enterprise and including different types of media;
normalizing the communication data ingested from the plurality of heterogeneous communication platforms;
aggregating and analyzing the normalized communication data;
providing a user interface enabling a user to submit a search query relating to participants or subject matters; and
presenting, over the user interface, search results, including visual representations of communications between two or more participants relating to the search query.

10. The method of claim 9, wherein the different types of media include text and audio.

11. The method of claim 9, wherein the plurality of heterogeneous communication platforms include at least two of: an email platform, a chat platform, a video platform, and a voice platform.

12. The method of claim 9, wherein ingesting communication data includes making application programming interface (API) calls to one or more of the communication platforms.

13. The method of claim 9, wherein the visual representations of communications between two or more participants include an indication of the types of communications between the two or more participants.

14. The method of claim 13, wherein the visual representations of communications between two or more participants include an indication of the number of each of the types of communications between the two or more participants.

15. The method of claim 9, wherein the visual representations of communications between two or more participants include a list of occurrences of communications between first and second participants.

16. The method of claim 15, wherein, one or more of the occurrences of communications between first and second participants include an indication of a risk level relating to the respective communication.

17. A computer programming product comprising a non-transitory computer-readable medium storing instructions translatable by a processor for:
ingesting communication data from a plurality of heterogeneous communication platforms, the communication data relating to communications between two or more participants in an enterprise and including different types of media;
normalizing the communication data ingested from the plurality of heterogeneous communication platforms;
aggregating and analyzing the normalized communication data;
providing a user interface enabling a user to submit a search query relating to participants or subject matters; and
presenting, over the user interface, search results, including visual representations of communications between two or more participants relating to the search query.

18. The computer programming product of claim 17, wherein the different types of media include text and audio.

19. The computer programming product of claim 17, wherein the plurality of heterogeneous communication platforms include at least two of: an email platform, a chat platform, a video platform, and a voice platform.

20. The computer programming product of claim 17, wherein the visual representations of communications between two or more participants include a list of occurrences of communications between first and second participants.
